(19) United States
(12) Patent Application Publication
(10) Pub. No.: US 2006/0194171 A1
(43) Pub. Date: Aug. 31, 2006

(54) Bi-polar implant

(76) Inventor: Sargon Lazarof, Encino, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 11/414,820

(22) Filed: Apr. 29, 2006

Related U.S. Application Data
(63) Continuation-in-part of application No. 10/679,248, filed on Oct. 3, 2003.

(51) Int. Cl. A61C 8/00

(52) U.S. Cl. 433/173

(57) ABSTRACT

A bi-polar implant system for use in a patient's jawbone includes an undersized drill shaped cavity formed in a patient's jawbone for receiving a bi-polar implant assembly. A proximal tapered portion is positioned at a proximal end of the bi-polar implant assembly. An expandable skirt portion adjacent to the proximal tapered portion forms a distal end of the bi-polar implant assembly, where the expandable skirt portion includes a plurality of moveable bone anchor segments. A draw screw has a threaded shank portion positioned to cooperate with an expansion nut. Rotation of the draw screw draws the expansion nut upwards into the expandable skirt portion for forcing the movable bone anchor segments into locking engagement with the jawbone. The proximal tapered portion and the expandable skirt portion exhibit an hourglass shape for providing double compaction on the jawbone within the drill shaped cavity for stabilizing the bi-polar implant assembly.

This patent application is a continuation-in-part application under 37 C.F.R. Section 1.53(b)(2) of co-pending patent application having Ser. No. 10/679,248 filed Oct. 3, 2003.

### BACKGROUND OF THE INVENTION

1. Technical Field

The present invention relates generally to implants and processes for preparing implants such as dental prostheses. More particularly, the present invention concerns a bi-polar implant having an expandable skirt portion which is tapered outward at a distal end when expanded and a tapered upper hood and tapered tubular body at a proximal end, the implant design exhibiting an hourglass shape resulting in double compaction on the patient's jawbone for providing osseointegration and a stable lock within the jawbone of a patient.

2. Background Art

Dental implants of the character which are receivable within a bore provided in a patient's jawbone are old in the art. Typically, such dental implants comprise an apertured body portion which is placed within a bore drilled in the jawbone. The body portion is typically designed so that during a period of several months after its emplacement within the bore formed in the jawbone, bone tissue will grow into the aperture so as to secure the body portion of the dental implant in place within the jawbone bore. At some point in the treatment, an artificial tooth or other prosthetic component is secured to the body portion.

These procedures are undesirable in several respects. In the first place, the procedure is protracted and requires multiple visits to the oral surgeon. Secondly, during the extended period of time required for the bone tissue to grow into and around the dental implant, the patient can have an uncomfortable and unsightly cavity where the prosthetic component, such as an artificial tooth, will eventually be secured. Additionally, these procedures do not always provide adequate anchoring of the dental implant to the jawbone so that over time, the implant can become loose, requiring further remedial work or an alternative procedure.

It is stressed that a dental implant, in order to be stable, must achieve contact with the jawbone on the implant surface. This process is referred to as osseointegration. In particular, the implant must be stable without any micro-movement for osseointegration to occur. Consequently, the implant must exhibit circumferential stability, that is, the implant must not rotate on its own axis once installed. Means must be provided in order to prevent the implant from rotating on its own axis. If the implant is not circumferentially stable and micro-movement occurs, osseointegration will not occur. Thus, there will not be any contact or growth of the jawbone on the dental implant surface. Only a fibrous connection or soft tissue growth on the dental implant will occur but not bone growth. This soft tissue or fibrous growth on the dental implant is easily torn away when an implant prosthetic is applied to the implant abutment. This results in poor implant stability.

In an effort to increase the stability of dental implants of the past, the cavity which resulted from the extraction of a tooth, or in the alternative, the healed site of a previously extracted tooth, might be drilled to provide an opening to accommodate the dental implant. In this prior art procedure, a mechanical tap was utilized to form threads on the interior surface of the cavity. The mechanical tap was then removed. Thereafter, the dental implant which might include threads formed on the outer surface thereof, was inserted in and threaded into the cavity. The threads formed on the outer surface of the dental implant would then cooperate and mesh with the threads formed on the interior surface of the cavity.

Several types of dental implants utilizing mechanical locking means for securing the dental implant in place within the bore formed within the patient's jawbone have been developed. Examples of such devices is the device described in U.S. Pat. No. 3,708,883 issued to Flander. Other dental implants are illustrated and described in U.S. Pat. Nos. 5,004,421; 5,087,199; and 6,142,782 each issued to Lazarof. The Lazarof dental implant makes use of mechanical securement means, but unlike the Flander device, the Lazarof device includes means by which selected dental prosthetics of standard design can be threadably interconnected. In this way, angular corrections of the prosthetic, such as an artificial tooth, can readily be made.

Further, in one form, these prior Lazarof implants are positively secured within the bore in the jawbone by two separate but cooperating securement mechanisms. The first securement mechanism comprises self-tapping, external threads provided on the tubular body of the device which are threaded into the jawbone by rotating the device in a first direction. The second cooperating securement mechanism comprises a plurality of bone penetrating anchor blades formed on the skirt portion of the tubular body which are moved into a bone engagement position only after the implant has been securely threaded into the jawbone. The anchor blades are moved into the bone engagement configuration by rotating a threaded expander member also in a first direction. However, because the threads of the expander member are opposite to the threads on the tubular body, rotational forces exerted on the expander member continuously urge the implant into a tightening direction. In other words, as the anchor blades are urged outwardly, the dental implant is continuously urged into threaded engagement with the jawbone. This locking approach permits the selected prosthetic component to be connected to the implant immediately.

Two addition prior art references worthy of note include U.S. Pat. No. 2,721,387 issued to Ashuckian and U.S. Patent Publication No. US2003/0087217 by Coatoam. Ashuckian '387 relates to artificial teeth which are adapted to be inserted in the socket of a tooth which has just been extracted so as to take the place of the extracted tooth. Further, the artificial teeth disclosed by Ashuckian '387 are retained in the position of the extracted tooth without bridging or other support from the proximal or other teeth in a denture. The construction of the artificial tooth disclosed by Ashuckian '387 have one or more roots which are inserted in a tooth socket immediately after the extraction of a natural tooth therefrom. The artificial tooth is expandable transversely of the axis of the root so as to firmly engage the walls of the tooth socket. The outer surfaces of the inserted root are roughened to form outer projections and the walls formed with either deep depressions therein or holes there through so that immediately upon installation, expansion of the root will firmly establish the artificial tooth to prevent such movements as would make impossible integration in a process known as the alveolar process while during healing the surrounding structure fills in these openings in the artificial tooth root to accomplish integration.

U.S. Patent Application Publication No. US2003/0087217 A1 by Coatoam discloses a dental implant having an elongated body with a first and second end portion and having a root on one end portion for attaching to a patient's jawbone to replace the root of a removed tooth. The root portion has an anatomically shaped portion between the end portions of the body for fitting into a jawbone opening below the gum tissue of a patient when the root is attached to a jawbone. An artificial tooth abutment is formed on the other end of the elongated body for attaching an artificial tooth thereon of the abutment extending above the gum line of a patient. A method of attaching a dental implant includes the steps of extracting a patient's tooth and selecting the dental implant of the apparatus and attaching the dental implant root with the jawbone of a patient with the abutment extending above the gum tissue of the patient and attaching the artificial tooth to the abutment.

Thus, there is a need in the art for a bi-polar implant for inserting into a cylindrically drilled hole in the jawbone of a patient to replace an extracted natural tooth, the bi-polar implant providing greater dental implant security since the instant invention accounts for the natural tapered shape of the cavity resulting from the tooth extraction, the instant invention having an upper tapered hood at a proximal end as well as an expandable skirt portion at a distal end, the skirt portion being expanded by an expansion nut being drawn upward into the skirt portion via a draw screw, the upper tapered hood and the expandable skirt portion exhibiting an hourglass shape resulting in double compaction on the patient's jawbone for promoting osseointegration and in combination with a plurality of bone penetrating protuberances resulting in a stable, non-rotating lock within the jawbone of a patient.

### DISCLOSURE OF THE INVENTION

The present invention is a bi-polar implant assembly that compacts bone bi-directionally resulting in an improved, more stable dental implant. The natural configuration of a cavity created by an extracted tooth tapers and expands outwardly towards the gum line. The invention improves the stability of the bi-polar implant assembly and addresses the configuration of a natural cavity after tooth removal.

Briefly and in general terms, the present invention provides a new and improved dental implant identified as a bi-polar implant assembly. In a preferred embodiment of the invention, the bi-polar implant assembly includes a tapered hood that tapers outward in the direction of an oral cavity formed within a patient's jawbone. The oral cavity exists as a result of the extraction of a tooth. Positioned just adjacent to the tapered hood on the bi-polar implant assembly is a tapered tubular body that communicates with a non-tapering expandable skirt portion which is receivable within an undersized cylindrically drill shaped cavity or bore provided in the jawbone of the patient. The tapered hood and the tapered tubular body combine to form a proximal tapered portion at a proximal end of the bi-polar implant assembly. The term “undersized” as used here is intended to mean that the diameter of the proximal tapered portion of the bi-polar implant assembly is greater than the diameter of the cylindrical drill shaped cavity.

A draw screw is positioned within the tapered tubular body, the draw screw having a slotted head which is captured within the hollow body of the tapered tubular body. The slotted head of the draw screw is connected to a threaded shank portion which extends to a terminal end of the skirt portion at the distal end of the bi-polar implant assembly. The slotted head of the draw screw engages an internal shoulder formed within the tapered tubular body to form a seal which isolates a first hollow body chamber located on one side of the slotted head of the draw screw from a second hollow body chamber located on an opposite side of the slotted head. An expansion nut, which is receivable within the terminal end of the expandable skirt portion, comprises an inner threaded cavity into which the threaded shank portion of the draw screw is received. Rotation of the draw screw through the inner threaded cavity of the expansion nut causes the expansion nut to be drawn into the terminal end of the expandable skirt portion. Expansion of the skirt portion by the insertion of the expansion nut results in radial movement of a plurality of separately movable bone anchor segments of the expandable skirt portion from a first retracted position to a second expanded position. Rotation of the draw screw is accomplished by manipulating the slotted head with an appropriate tool. The separately movable bone anchor segments include a plurality of progressively tapered bone penetrating protuberances. Upon complete insertion of the bi-polar implant assembly within the drill shaped cavity (but before expansion of the bone anchor segments), the progressively tapered bone penetrating protuberances begin to cut into the jawbone of the patient to assist in securing the bi-polar implant assembly in place by providing initial anchorage and circumferential stability. Subsequent rotation of the draw screw will not result in the rotation of the bi-polar implant assembly around its own vertical axis as is the case with prior art dental implants that do not enjoy an initial anchorage provided by the bone penetrating protuberances.

Expansion of the skirt portion, by drawing the expansion nut upwards onto the threaded shank portion, causes the terminal end of the expandable skirt portion to be flared or expanded outward. Likewise, the tapered hood and tapered tubular body on the proximal end of the bi-polar implant assembly is tapered or flared outwards in the direction of the oral cavity. This construction results in a double taper providing an hourglass-shape, i.e., an outward flared taper on each of the proximal and distal ends of the bi-polar implant assembly. It is the outward flare of the tapered hood located at the proximal end of the bi-polar implant assembly in combination with the outward flare of the expandable skirt portion located at the distal end of the bi-polar implant assembly that provides a two-sided, hourglass-shaped sandwich lock resulting in a “double-compaction”, i.e., a compacting from two sides, on the patient's jawbone. Hence, the term “bi-polar” implant. This construction dramatically improves the stability of the bi-polar implant assembly once implanted into the cylindrical drill shaped cavity or bore within the patient's jawbone because the implant assembly is circumferentially stable, eliminates any micro-movement, and promotes an increase in bone density and superior osseointegration so that the patient's jawbone contacts and binds to the surface of the bi-polar implant assembly.

Furthermore, the robust bone engaging protrusions located on the tapered tubular body of the proximal tapered portion and the progressively tapered bone penetrating protuberances located along the length of the separately moveable bone anchor segments of the distal end provide a self-tapping bone engaging means when engaging an internal surface of the undersized cylindrical drill shaped cavity. This engagement of the internal surface of the undersized cylindrical drill shaped cavity provides secure anchoring and prevents rotation of the bi-polar implant assembly around its own vertical axis. Additionally, the small tapered bone penetrating protuberances located close to and at the terminal end of the expandable skirt portion do not cut into or anchor in the jawbone of the patient to avoid damaging the delicate bone anchor segments.

After a fresh tooth extraction, a cavity exists where the tooth was located. In the case of an old tooth extraction, the extraction site may have healed over. Thus, the cavity no longer exists. In either case, the existing cavity or a newly drilled cavity in the healed-over site are made cylindrical in shape by utilizing round dental drills. In a new cavity existing from a recent tooth extraction, the round dental drills are utilized to ensure that an odd-shaped cavity is cylindrical. In an old tooth extraction site that has healed over and filled with tissue, the cylindrical cavity is drilled into the jawbone of the patient to accommodate the bi-polar implant assembly. In either case, the proximal tapered portion comprising the tapered hood and the tapered tubular body has a greater diameter than the cylindrical drill shaped cavity so that the bi-polar implant assembly now compacts the drill shaped cavity. In other words, the diameter of the drill shaped cavity is undersized when compared to the diameter of the bi-polar implant assembly. The undersized cylindrical drill shaped cavity cooperates with the self-tapping bone engaging means formed on the proximal tapered portion and the expandable skirt portion of the bi-polar implant assembly to ensure a secure fitment.

The present invention is generally directed to a bi-polar implant system typically employed for insertion into the jawbone of a dental patient to replace a previously extracted tooth. In its most fundamental embodiment, the bi-polar implant system for use in a jawbone of a patient includes a cylindrical drill shaped cavity formed in a jawbone of a patient. The drill shaped cavity is undersized for receiving a bi-polar implant assembly which includes a tapered hood. A tapered tubular body adjacent to the tapered hood are combined to form a proximal tapered portion at a proximal end of the bi-polar implant assembly. An expandable skirt portion is adjacent to the tapered tubular body for forming a distal end of the bi-polar implant assembly, where the expandable skirt portion includes a plurality of moveable bone anchor segments. A draw screw has a threaded shank portion positioned within the tapered tubular body that cooperates with an expansion nut. Rotation of the draw screw draws the expansion nut upward into the expandable skirt portion for forcing the movable bone anchor segments into locking engagement with the jawbone. The proximal tapered portion at the proximal end and the expandable skirt portion at the distal end exhibits an hourglass shape for providing double compaction on the jawbone within the undersized cylindrical drill shaped cavity for stabilizing the bi-polar implant assembly.

In an alternative embodiment of the present invention, the bi-polar implant assembly includes a tapered hood having a portion removed so that the resulting circumference of the tapered hood is non-circular.

In another embodiment of the present invention, the bi-polar implant assembly includes a tapered hood that is located adjacent to a plurality of beveled coronal rings which are attached to an upper hex collar.

In yet another embodiment of the present invention, the tapered hood is located adjacent to an upper hex collar, the upper hex collar having a circumference that is equal to the largest circumference of the tapered hood.

In a final alternative embodiment of the present invention, the abutment is permanently integrated into the upper hex collar of the bi-polar implant assembly by machining, eliminating the need for attaching a separate abutment.

These and other objects and advantages of the present invention will become apparent from the following more detailed description, taken in conjunction with the accompanying drawings which illustrate the invention, by way of example.

### BRIEF DESCRIPTION OF THE DRAWINGS

The accompanying drawings illustrate the invention. In such drawings:

FIG. 1 is a side view of a preferred embodiment of the bi-polar implant assembly of the present invention showing a tapered hood connected to a tapered tubular body, a skirt portion, a draw screw, an expansion nut, an abutment and a prosthetic component, where the expandable skirt portion is partially flared at a terminal end caused by the expansion nut being partially drawn upwards therein.

FIG. 2 is a longitudinal cross-sectional view of the bi-polar implant assembly taken along line 2-2 of FIG. 1 showing the tapered hood, tapered tubular body, a plurality of abutment threads, the expandable skirt portion, the draw screw including a screw head, and the expansion nut, where the skirt portion is partially flared at a terminal end caused by the expansion nut being partially drawn upwards therein.

FIG. 3 is a detail view of the expansion nut fitted within the terminal end of the expandable skirt portion of the bi-polar implant assembly of FIG. 1.

FIG. 4 is a side view of the preferred embodiment of the bi-polar implant assembly with the abutment, prosthetic component and draw screw removed, and showing the tapered hood and three of the four bone anchor segments which form the skirt portion and exhibit progressively tapering bone penetrating protuberances.

FIG. 5 is a top plan view of the tapered hood of the bi-polar implant assembly of FIG. 4 showing the upper hood, the beveled coronal rings, and the upper hex collar.

FIG. 6 is a rotated detail view of the terminal end of the expandable skirt portion of the bi-polar implant assembly of FIG. 4 showing a circumferentially spaced tapered slit positioned between each adjacent pair of the four bone anchor segments.

FIG. 7 is a longitudinal cross-sectional view of the bi-polar implant assembly of FIG. 1 taken along the line 7-7 of FIG. 4 showing the tapered upper hood including an abutment interface, a plurality of abutment threads, and two hollow chambers formed within the tapered tubular body, and further showing the expandable skirt portion exhibiting progressively tapering bone penetrating protuberances.

FIG. 8 is a frontal view of the bi-polar implant assembly of FIG. 1 showing the implant assembly mounted within a cavity of the patient's jawbone and illustrating a proximal tapered portion comprising the tapered hood and the tapered tubular body, and a distal end comprising the expandable skirt portion with the expansion nut fully drawn upwards therein, the construction forming an hourglass- shape for anchoring the bi-polar implant assembly within the patient's jawbone.

FIG. 9 is a side elevation of an alternative embodiment of the bi-polar implant assembly wherein a portion of the hood has been removed, and further showing three of the four bone anchor segments which form the expandable skirt portion and exhibit progressively tapering bone penetrating protuberances.

FIG. 10 is a top plan view of the alternative embodiment of the bi-polar implant assembly of FIG. 9 showing the upper hex collar, beveled coronal rings, and a modified upper hood.

FIG. 11 is a side elevation of a decayed tooth extending from the jawbone of a patient prior to being manually extracted.

FIG. 12 is another side elevation of the decayed tooth being manually extracted by employing a dental extracting instrument.

FIG. 13 is a side elevation of a cavity existing within the jawbone of the patient after the decayed tooth including the root has been extracted.

FIG. 14 is a side elevation of the cavity formed by the extraction of the decayed tooth being shaped by a dental drill for accommodating the bi-polar implant assembly.

FIG. 15 is a side elevation of the cavity formed within the jawbone of the patient after being shaped by the dental drill for accommodating the bi-polar implant assembly.

FIG. 16 is a side elevation of a bi-polar implant system comprising the bi-polar implant assembly inserted into the drill-shaped cavity within the jawbone of the patient and showing the tapered tubular body, bone engaging protrusions, a pair of the bone anchor segments including the progressively tapered bone penetrating protuberances, and the expansion nut positioned within the terminal end of the expandable skirt portion.

FIG. 17 is a side view of the bi-polar implant system with the slotted head of the draw screw being rotated by an appropriate tool for threading the expansion nut onto the draw screw and into the terminal end of the expandable skirt portion for expanding the distal end of the bi-polar implant assembly.

FIG. 18 is a side elevation of the bi-polar implant system with the bi-polar implant assembly anchored in the drilled-shaped cavity of the jawbone with the expansion nut fully drawn into and expanding the distal end of the implant assembly, and with the bone engaging protrusions of the tapered tubular body and the bone penetrating protuberances of the expandable skirt portion each anchored in the jawbone of the patient.

### DETAILED DESCRIPTION OF THE INVENTION

As shown in the drawing Figs. for purposes of illustration, the present invention is directed to a bipolar implant such as, for example, a bi-polar dental implant. However, it will be understood that the present invention may be applied to various types of implantable prosthetic devices or appliances and thus is not limited to dental implants.

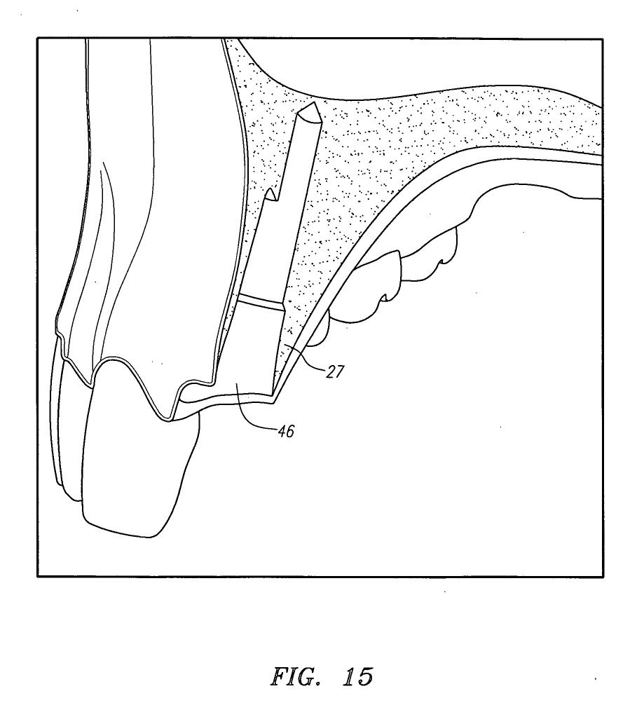

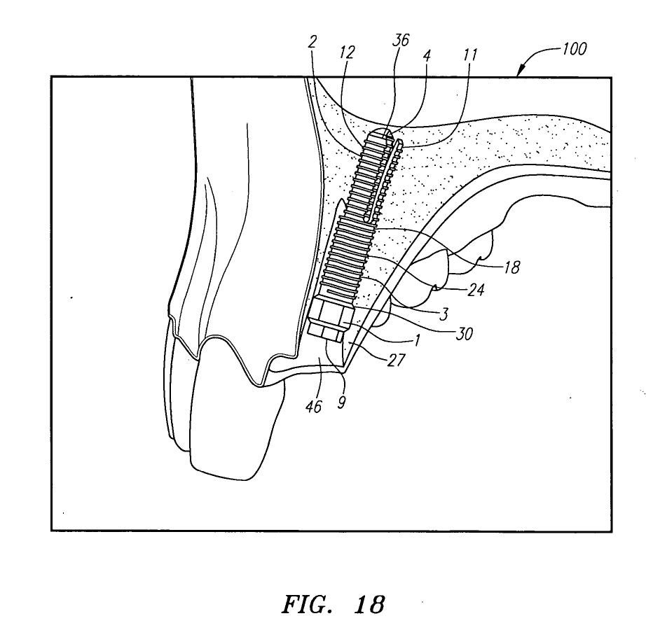

In particular, the preferred embodiment of the present invention is directed to a bi-polar implant system 100 comprising a bi-polar implant assembly 18 shown in FIG. 1 in combination with an undersized, cylindrical drill shaped cavity 46 shown best in FIGS. 15 and 18. The description of these two separate subsystems is set out below with the description of the bi-polar implant assembly 18 appearing first.

With reference to FIGS. 1-3, the bi-polar implant assembly 18 comprises a hood 1, which includes an upper hood 21 and a lower hood 19. The hood 1 extends in the direction of the upper hood 21 as is shown in FIG. 1. The tapered shape of the hood 1 better accommodates the shape of a cavity 28 within the jawbone 27 of a patient's mouth, the cavity 28 resulting from the extraction of a tooth. The bi-polar implant assembly 18 includes a proximal tapered portion 30 which extends from the upper hood 21 through the lower hood 19 of the hood 1 and along a tapered tubular body 3 as is clearly shown in FIG. 1. The tapered shape of the proximal tapered portion 30 accommodates the natural tapered shape of the cavity 28 within the patient's jawbone 27 resulting from a tooth extraction.

The upper hood 21 is adjacent to a series of beveled coronal rings 20 wherein the beveled coronal rings 20 serve as an interface between the bi-polar implant assembly 18 and an upper hex collar 9. Once an abutment 6 and upper hex collar 9 are engaged, relative rotation there between is not possible due to the hexagonal or multi-sided circumference. A prosthetic component 25 such as, for example, an artificial tooth can be attached to and terminated on the upper hood 21 as shown in phantom in FIG. 1. Abutment threads 5 are present within the center core of the hood 1, where the abutment 6 can be threadedly received as shown in FIGS. 1 and 2. Alternately, the abutment 6 may be permanently joined to the bi-polar implant assembly 18, depending on the preference of the dental professional.

Adjacent to the lower hood 19 is the tapered tubular body 3 as is shown in FIGS. 1 and 2. The tapered tubular body 3 tapers outward towards the hood 1. The outside surface of the tapered tubular body 3 includes bone engaging protrusions 24 as shown in FIG. 2 which are designed to cut or carve into the jawbone 27 of the patient when the bi-polar implant assembly 18 is installed in the cavity 28. The tapered tubular body 3 terminates at the lower hood 19 as shown in FIG. 1. Further, the tapered tubular body 3 is provided with the internal abutment threads 5 which are adapted to threadedly receive the abutment 6.

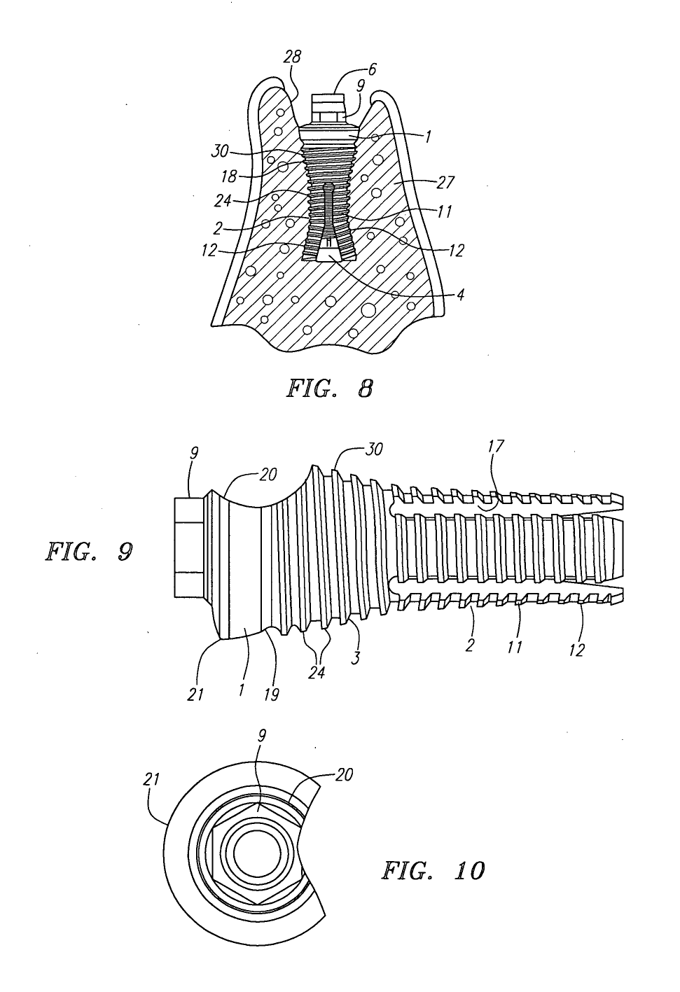

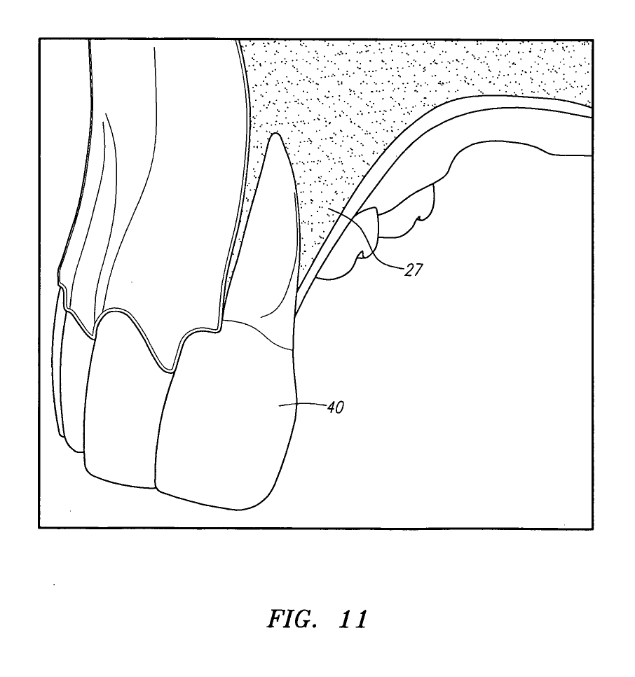

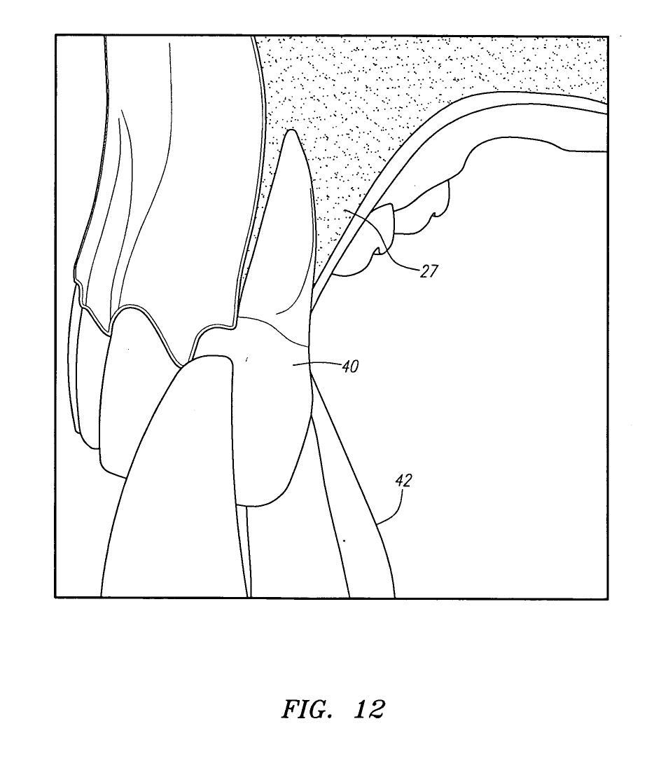

Next to the tapered tubular body 3 is an expandable skirt portion 2 which is radially movable from a first retracted position to a second expanded position. To move the expandable skirt portion 2 to the second expanded position, there is provided an expander means shown in FIG. 2 as comprising an expansion nut 4 and a draw screw 8. As shown in FIGS. 2 and 7, the tapered tubular body 3 includes an internal shoulder 13 on which a slotted head 22 of the draw screw 8 rests. A threaded shank portion 7 of the draw screw 8 extends below the internal shoulder 13 generally to a lower end of the tapered tubular body 3 where the expansion nut 4 is threaded onto the threaded shank portion 7.

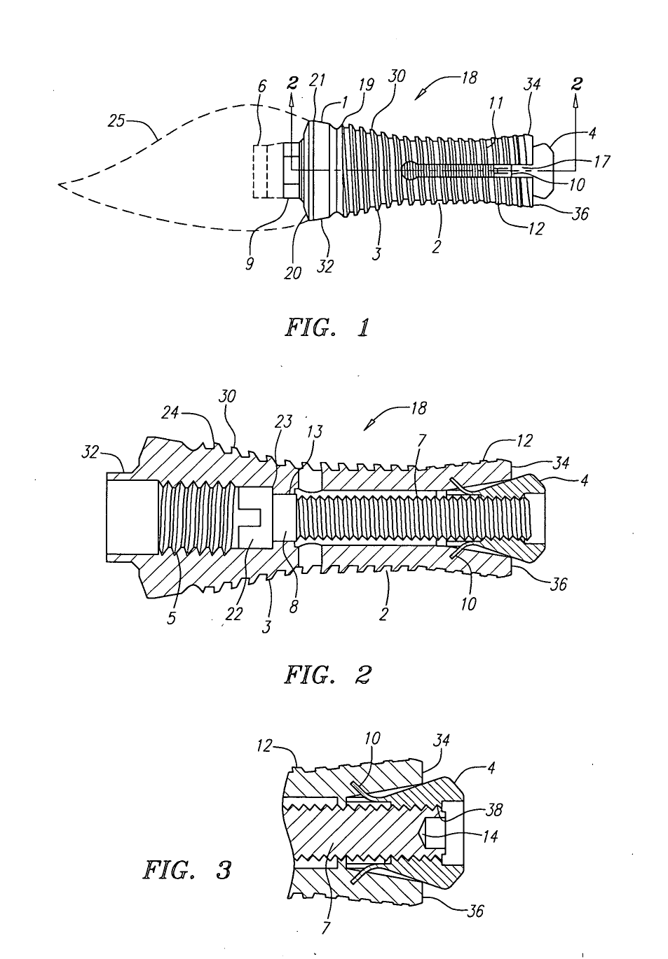

Referring to FIG. 3, the end of the threaded shank portion 7 includes a slot 14 that enables the end of the draw screw 8 to be enlarged after the expansion nut 4 is threaded thereon. This design prevents the expansion nut 4 from being inadvertently disassociated from the draw screw 8 within the bore or cavity 28 of the patient's jawbone 27.

Importantly, the draw screw 8 is configured to sealingly engage the internal shoulder 13 of the tapered tubular body 3 to isolate a first hollow body chamber 15 from a second hollow body chamber 16 as shown in FIG. 7. The first hollow body chamber 15 is defined as the area within the tapered tubular body 3 beneath the internal shoulder 13 into which the threaded shank portion 7 extends. The second hollow body chamber 16 is defined as the interior of the tapered tubular body 3 above the internal shoulder 13. In this regard, the slotted head 22 of the draw screw 8 has a tapered (non-ninety-degree) shoulder 23. When the tapered shoulder 23 of slotted head 22 engages the internal shoulder 13 of the tapered tubular body 3 (as the expansion nut 4 is drawn upwardly into the expandable skirt portion 2) causes a cold weld between the facing portions of the slotted head 22 and the internal shoulder 13. This feature is best shown in FIG. 2.

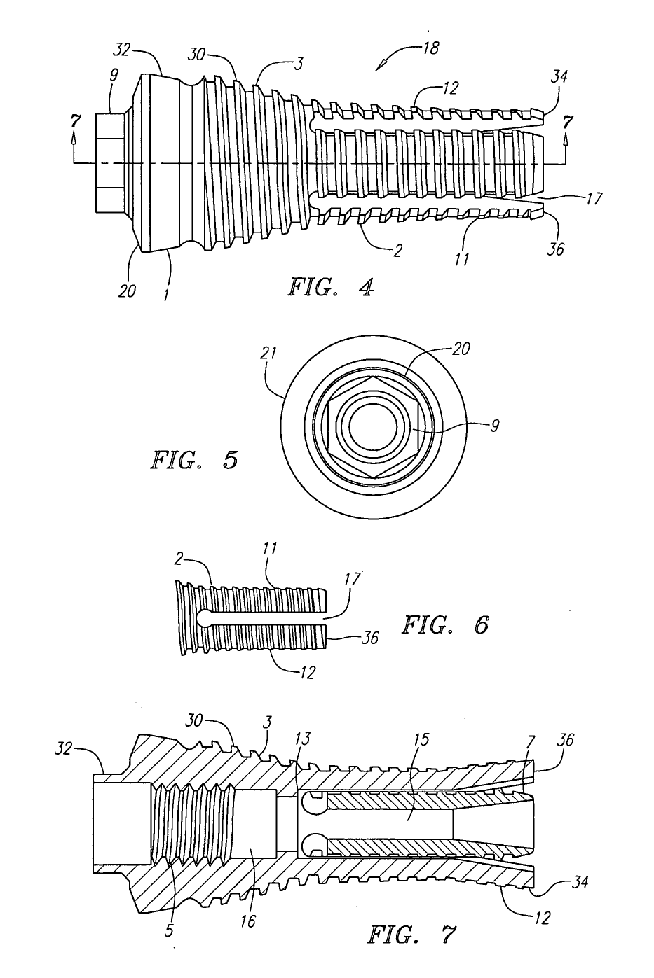

As is most clearly shown in FIG. 4, the expandable skirt portion 2 of the bi-polar implant assembly 18 is provided with four circumferentially spaced tapered slits 17 which define four separately movable bone anchor segments 11. Each of the four separately movable bone anchor segments 11 comprise bone penetrating means formed on an exterior surface thereof. The bone penetrating means is provided in the form of a series of longitudinally spaced, blade-like bone penetrating protuberances 12. As the expansion nut 4 is drawn upward into the expandable skirt portion 2, the bone anchor segments 11 will be expanded outwardly so that the bone penetrating protuberances 12 slice into the jawbone 27 in a manner to securely lock the expandable skirt portion 2 within the cavity 28 of the patient's jawbone 27. As the expansion nut 4 is being drawn upward into the expandable skirt portion 2, a plurality of tabs 10 which extend outwardly from an upper portion of the expansion nut 4 travel upward through the circumferentially spaced tapered slits 17. By causing the plurality of tabs 10 to travel upward through the tapered slits 17, the expansion nut 4 is prevented from rotating relative to the expandable skirt portion 2 as shown in FIGS. 1-3.

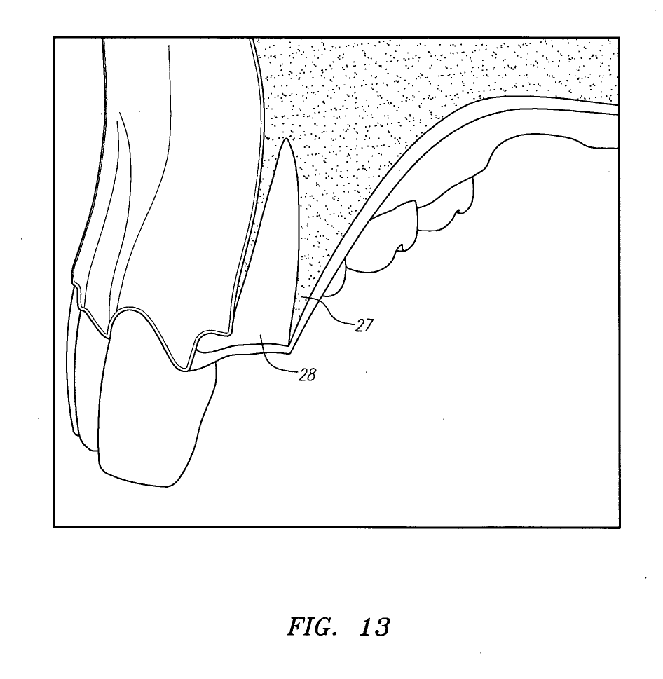

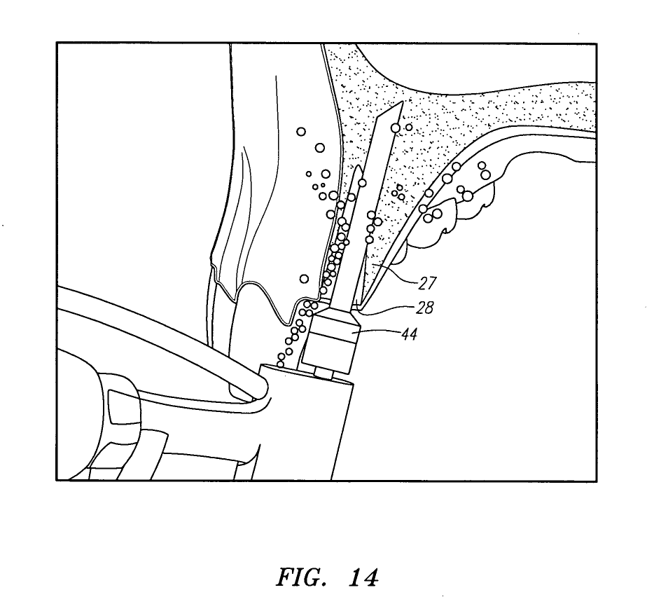

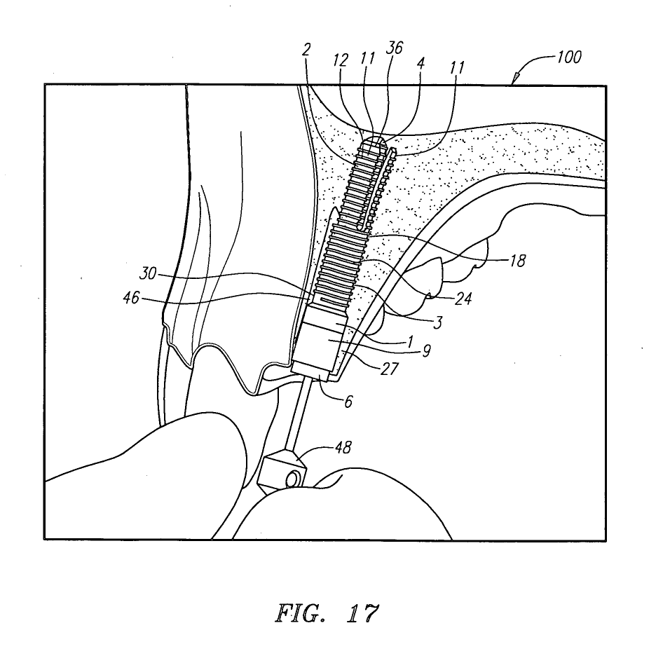

Prior to placing the bi-polar implant assembly 18 within the jawbone 27 of the patient as shown in FIG. 8, the implant assembly 18 is prepared by simply placing the draw screw 8 within the tapered tubular body 3 so that the slotted head 22 of the draw screw 8 rests against the internal shoulder 13. The expansion nut 4 is then threaded onto the bottom end of the threaded shank portion 7 just enough to ensure that the plurality of tabs 10 of the expansion nut 4 will be properly aligned with the circumferentially spaced tapered slits 17 as is shown in FIG. 1. This combination of the tapered tubular body 3, draw screw 8, expansion nut 4 and plurality of tabs 10 as shown in FIG. 2 is then fitted within the undersized, cylindrical drill shaped cavity 46 mentioned above and discussed in more detail herein below in relation to FIGS. 14 and 15. The drill shaped cavity 46 is the cavity 28 (see FIG. 13) in the patient's jawbone 27 after being made cylindrical by being turned or reamed by round drills as shown in FIG. 14. A mechanical screwdriver or allen wrench can be inserted through the upper end of the tapered tubular body 3 as is clearly shown in FIG. 17 to turn the draw screw 8 for the purpose of drawing the expansion nut 4 upward onto the threaded shank portion 7 and into the expandable skirt portion 2.

As the bi-polar implant assembly 18 is inserted into the undersized, cylindrical drill shaped cavity 46, the expansion nut 4 and a terminal end 36 of the expandable skirt portion 2 will reach the bottom of the drill shaped cavity 46. At this point, the movable bone anchor segments 11 of the expandable skirt portion 2 are initially forced outward because the bottomed expansion nut 4 applies outward pressure on the bone anchor segments 11. This action occurs prior to the draw screw 8 being operated. This initial expansion of the bone anchor segments 11 causes the associated bone penetrating protuberances 12 to provide an “initial anchorage” that prevents the bi-polar implant assembly 18 from rotating on its own vertical axis during installation, i.e., provides “circumferential stability”, (when the draw screw 8 is subsequently operated). This “initial anchorage” of the bi-polar implant assembly 18 occurs because the bone penetrating protuberances 12 cut into the interior sidewall of the drill shaped cavity 46. This feature distinguishes the bi-polar implant assembly 18 of the present invention from the cited prior art. The dental implants of the prior art do not incorporate structure that prevents rotation of the dental implant about its own vertical axis when the draw screw is operated, i.e., there is no “circumferential stability”.

The tapered hood 1 and the tapered tubular body 3 of the proximal tapered portion 30 has a diameter or cross-dimension greater than the diameter or cross-dimension of the undersized, cylindrical drill shaped cavity 46 as is discussed in more detail below in relation to the formation of the drill shaped cavity 46. Consequently, the insertion of the bi-polar implant assembly 18 causes compaction in the upper section of the undersized cylindrical drill shaped cavity formed in the jawbone 27. When the bi-polar implant assembly 18 is inserted into the drill shaped cavity 46, the progressively tapered, bone penetrating protuberances 12 act as threads which bite into the vertical sidewall of the drill shaped cavity 46 further enhancing the effect of the “initial anchorage”. It is important to note that the “initial anchorage” provided by the initial expansion of the bone anchor segments 11 and the cutting into the interior sidewalls of the dental shaped cavity 46 by the bone penetrating protuberances 12 provide the bi-polar implant assembly 18 with “circumferential stability”. The “circumferential stability” of the bi-polar implant assembly 18 implies stability, that is no micro-movement. The absence of micro-movement promotes superior “osseointegration” which promotes contact or bone growth over the exterior surface of the bi-polar implant assembly 18. This condition provides the maximum stability possible to achieve with the bi-polar implant assembly. The draw screw 8 is then operated with a suitable tool 48 as is shown in FIG. 17 to expand the skirt portion 2 as shown in FIG. 18. When the draw screw 8 is turned in the appropriate direction, the bone anchor segments 11 are caused to expand outwardly. In particular, as the expansion nut 4 is drawn into expandable skirt portion 2, the bone anchor segments 11 further expand outwardly so that the bone penetrating protuberances 12 continue to slice or cut into the patient's jawbone 27 in a manner to securely lock the bi-polar implant assembly 18 in place in the drill shaped cavity 46. Further, the plurality of tabs 10 fitted within the circumferentially spaced tapered slits 17 ensure that the expansion nut 4 does not rotate relative to the expandable skirt portion 2. The bi-polar implant assembly 18 is now installed and as is shown in FIGS. 8 and 18, includes the tapered hood 1 compacted into the top section of the drill shaped cavity 46 and an expanded skirt portion 2 with the bone anchor segments 11 compacting the bottom section of the drill shaped cavity 46. This construction exhibits an hourglass shape and provides a “double compaction” on the jawbone 27 of the patient. The tapered hood 1 on the proximal end 32 and the outwardly tapered expanded skirt portion 2 on the distal end 34 causes the bi-polar implant assembly 18 shown in FIGS. 8 and 18 to exhibit the hourglass shape. The “double compaction” effect on the jawbone 27 is caused by (1) the tapered hood 1 compacting the top section of the drill shaped cavity 46, and (2) the expanded bone anchor segments 11 compacting the bottom section of the drill shaped cavity 46.

The “double compaction” effect of the properly installed bi-polar implant assembly 18 on the drill shaped cavity 46 results in maximum stability since “micro-movement” of the bi-polar implant assembly 18 is eliminated. Consequently, osseointegration can occur which results in the increase of bone surrounding the bi-polar implant assembly 18. This result occurs for the following reasons. Osseointegration is a process that results in contact of the jawbone 27 with the surface of the bi-polar implant assembly 18. If osseointegration does not occur, then only a fibrous soft tissue connection results which is easily torn loose when the prosthetic component 25 is applied to the bi-polar implant assembly 18. Consequently, the bone growth associated with osseointegration is preferred. It is believed that when the jawbone 27 is subjected to light pressure, the bone density increases. The pressure on the jawbone 27 is applied by the unique design of the bi-polar implant assembly 18 in that the tapered hood 1 compacts the top section of the drill shaped cavity 46, and the bone anchor segments 11 compacts the bottom section of the drill shaped cavity 46. Thus, the hourglass construction of the bi-polar implant assembly 18 sandwiches the patient's jawbone 27 resulting in the “double compaction”. Furthermore, applying pressure on the jawbone 27 by virtue of the “double compaction” will fracture the jawbone 27 and it is known that the healing of the fractured bone results in a stronger bond and superior osseointegration providing greater stability to the bi-polar implant assembly 18.

Consequently, it is believed that the “double compaction” feature (i.e., compaction at the top section and the bottom section of the drill shaped cavity 46), the “undersized” cylindrical, drill shaped cavity 46, and the “self-tapping” bone penetrating protuberances 12 and bone engaging protrusions 24 are important features of the present invention. The term “self-tapping” as it relates to the bone penetrating protuberances 12 and bone engaging protrusions 24 indicates that upon insertion of the bi-polar implant assembly 18 into the drill shaped cavity 46 of the jawbone 27, the protuberances 12 and protrusions 24 are threaded into the internal surface of the drill shaped cavity 46. These inventive features are not known in the prior art.

Each of the bone anchor segments 11 of the expandable skirt portion 2 includes the plurality of bone penetrating protuberances 12 formed thereon. The bone penetrating protuberances 12 are a component of the bone engaging means utilized for engaging the internal surface of the undersized, cylindrical drill shaped cavity 46 for anchoring and preventing rotation of the bi-polar implant assembly 18. The bone penetrating protuberances 12 located higher on the expandable skirt portion 2 and adjacent to the tapered tubular body 3 are heavier in design, “self-tapping”, and are intended to cut into the internal surface of the drill shaped cavity 46. However, the lower bone penetrating protuberances 12 located closer to the terminal end 36 of the expandable skirt portion 2 are progressively smaller and finer when compared to those protuberances 12 located on the expandable skirt portion 2 adjacent to the tapered tubular body 3 as shown clearly in FIGS. 1, 2 and 7. The protuberances 12 located closer to the terminal end 36 are progressively tapered and made smaller and finer so that they do not cut into and engage the internal surface of the drill shaped cavity 46. This is because the terminal end 36 of the expandable skirt portion 2 is more delicate and it is undesirable to have the bone penetrating protuberances 12 and/or bone anchor segments 11 be damaged or fracture while engaging the hard jawbone 27. Thus, the lower protuberances 12 do not engage the hard jawbone 27 and thus are less likely to be damaged or fracture along with the corresponding bone anchor segments 11.

It is clearly shown in FIG. 1 that the prosthetic component 25 terminates on the upper hood 21 of the bi-polar implant assembly 18 and not on the abutment 6 as in prior art dental implants. In the prior art dental implants, the prosthetic tooth terminated on the abutment so that a “gap” existed. The “gap” existed particularly when the expansion nut was not drawn upward into the equivalent of the bone anchor segments so that the draw screw and internal shoulder were not sealing the equivalent component of the first hollow body chamber. Under these conditions, bacteria could enter the dental implant through the “gap” and cause infection. In the bi-polar implant assembly 18 of the present invention, since the prosthetic component 25 terminates on the upper hood 21, the previously existing “gap” is eliminated even if the expansion nut 4 is not drawn up into the bone anchor segments 11. Consequently, bacteria cannot enter the bi-polar implant assembly 18 since the “gap” no longer exists because the prosthetic component 25 now terminates on upper hood 21 and not on the abutment 6.

Furthermore, the prosthetic component 25 (typically an artificial tooth) is a separate component and is capable of being angled on its base. In particular, the prosthetic component 25 can be positioned on the bi-polar implant assembly 18 at a particular angle to satisfy a particular circumstance. Additionally, the prosthetic component 25 can include a male shaft extending therefrom that is receivable in an orifice or hole drilled within the mounting base of the prosthetic component 25 on the bi-polar implant assembly 18. Finally, a full or partial denture (not shown) can be formed to fit overtop of and to snap onto the mounting base provided on the bi-polar implant assembly 18. Each of these features clearly show the versatility of the bi-polar implant assembly 18 of the present invention.

The drill-shaped cavity 46 utilized in combination with the bi-polar implant assembly 18 will now be discussed in more detail. Two situations typically exist when dealing with a tooth extraction. Either the tooth extraction is a fresh extraction of the decayed tooth 40, or the decayed tooth 40 was previously extracted and the extraction site has since healed over and the previously existing cavity has filled in with tissue. The first situation of a fresh tooth extraction is shown in FIGS. 13-18. Likewise, the second situation dealing with a previous tooth extraction in which the extraction site has healed over is shown in FIG. 8. In either case, the existing cavity 28 shown in FIG. 13 or the new drill shaped cavity 46 shown in FIG. 15 in the healed-over site are made cylindrical in shape by utilizing round dental drills as is shown in FIG. 14.

Drawing FIGS. 11-18 illustrate the jawbone 27 of the patient and the process of extracting a decayed tooth such as the decayed tooth 40 shown in FIG. 11. The decayed tooth 40 is shown mounted in the jawbone 27. In the conventional manner, a dental extracting instrument 42 is employed to remove the decayed tooth 40 from the patient's jawbone 27 as shown in FIG. 12. The existing cavity 28 in the jawbone 27 from which the decayed tooth 40 has been recently extracted is clearly visible in FIG. 13. In the case of an old tooth extraction, the extraction site will be healed over and thus, the cavity 28 no longer exists since it has healed over and filled with tissue. The objective is to provide the cylindrical drill shaped cavity 46 to accommodate the bi-polar implant assembly 18. In a new cavity 28 resulting from a recent tooth extraction, a round dental drill 44 is utilized to ensure that an odd-shaped cavity 28 is made cylindrical in shape as is clearly shown in FIG. 14. In an old tooth extraction site that has healed over and filled in with tissue, the new cylindrical drill shaped cavity 46 is drilled into the jawbone 27 of the patient with the dental drill 44 to accommodate the bi-polar implant assembly 18. Under both situations, the cavity 28, whether recently created from a tooth extraction or healed over, is reconfigured into the cylindrical drill shaped cavity 46 within the patient's jawbone 27 by the round dental drill 44 as is clearly shown in FIG. 15.

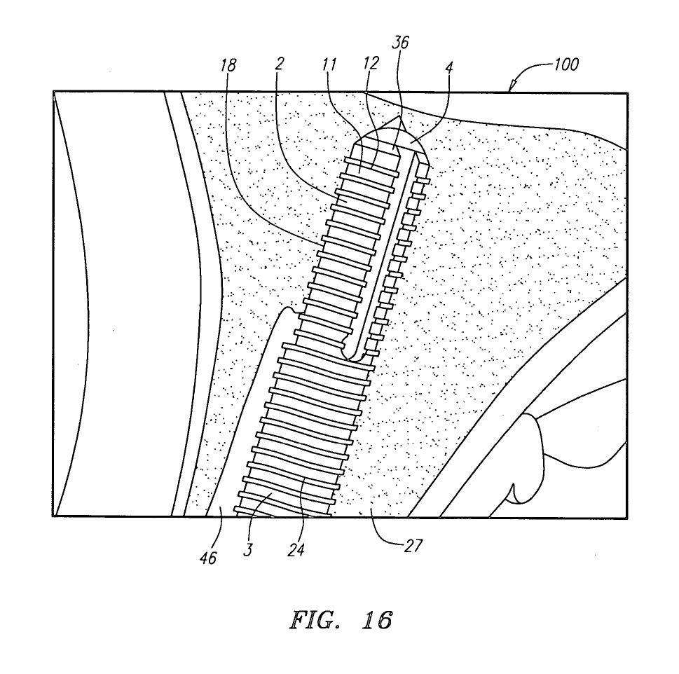

In either case, the proximal tapered portion 30 comprising the tapered hood 1 and the tapered tubular body 3 has a diameter or cross-dimension greater than the diameter or cross-dimension of the cylindrical drill shaped cavity 46 so that the bi-polar implant assembly 18 will compact the drill shaped cavity 46 upon insertion therein. In other words, the diameter or cross-dimension of the drill shaped cavity 46 is intentionally “undersized” when compared to the diameter or cross-dimension of the bi-polar implant assembly 18. The undersized, cylindrical drill shaped cavity 46 cooperates with the “self-tapping” bone engaging means formed on the proximal tapered portion 30 and the expandable skirt portion 2 of the bi-polar implant assembly 18 to ensure a secure fitment. The progressively tapered, bone penetrating protuberances 12 formed on the bone anchor segments 11 and the bone engaging protrusions 24 formed on the tapered tubular body 3 have a diameter greater than the diameter of the drill shaped cavity 46. Thus, this is what is meant by stating that the cylindrical drill shaped cavity 46 is '“undersized”. Consequently, when the bi-polar implant assembly 18 is mechanically inserted into the undersized drill shaped cavity 46, the bone penetrating protuberances 12 and the bone engaging protrusions 24 necessarily “self-tap” or cut into the jawbone 27 as is clearly shown in FIG. 16. This design ensures that the bi-polar implant assembly 18 is securely retained within the cylindrical drill shaped cavity 46 formed in the patient's jawbone 27.

After the bi-polar implant assembly 18 has been successfully installed into the undersized, cylindrical drill shaped cavity 46 as shown in FIG. 16, the suitable tool 48 is utilized to rotate the slotted head 22 of the draw screw 8 as shown in FIG. 17. This action causes the expansion nut 4 to ride upwards on the threaded shank portion 7 as shown in FIG. 2 and to expand the expandable skirt portion 2. The expandable skirt portion 2 is shown as outwardly tapered in FIG. 18 with the movable bone anchor segments 11 expanded outwardly into a secure locked position. The tapered hood 1 compacting the top section of the drill shaped cavity 46, and the bone anchor segments 11 compacting the bottom section of the drill shaped cavity 46 clearly illustrate the “double compaction” effect on the jawbone 27 in the present invention.

FIGS. 9 and 10 depict modifications to the embodiment of the bi-polar implant assembly 18 shown in FIG. 1-8. These modifications exhibit a bi-polar implant assembly 18 wherein a portion of the hood 1 has been removed. After the modifications, the resulting hood 1 has a circumference that is non-circular at any axial location in the hood 1. The purpose of this configuration is to allow for an alternative pattern of bone growth to surround the hood 1 of the tapered tubular body 3. The remaining structural components shown in FIGS. 9 and 10 include the expandable skirt portion 2, upper hex collar 9, separately movable bone anchor segments 11, circumferentially spaced tapered slits 17, lower hood 19, beveled coronal rings 20, upper hood 21, bone engaging protrusions 24, and proximal tapered portion 30. The function of each of these structural components is the same as that described with respect to the corresponding structure disclosed in FIGS. 1-8 as previously set forth above.

The present invention provides novel advantages over other dental implant apparatuses known in the prior art. The main advantages of the inventive bi-polar implant system 100 of the preferred embodiment include the two subsystem design including the novel bi-polar implant assembly 18 shown in FIG. 1 in combination with the undersized, cylindrical drill shaped cavity 46 shown best in FIGS. 15 and 18. In particular, the tapered hood 1 and tapered tubular body 3 on the proximal end 32 and the outwardly tapered expanded skirt portion 2 on the distal end 34 causes the bi-polar implant assembly 18 shown in FIGS. 8 and 18 to exhibit the hourglass shape. The tapered hood 1 compacting the top section of the drill shaped cavity 46, and the expanded bone anchor segments 11 compacting the bottom section of the drill shaped cavity 46 provide the “double compaction” effect on the jawbone 27 resulting in maximum stability since “micro-movement” of the bi-polar implant assembly 18 is eliminated. Consequently, osseointegration can occur which results in the increase of bone surrounding the bi-polar implant assembly 18 within the jawbone 27. Further, the bone engaging means comprising the bone penetrating protuberances 12 and bone engaging protrusions 24 is “self-tapping” meaning that upon insertion of the bi-polar implant assembly 18 into the drill shaped cavity 46 of the jawbone 27, the protuberances 12 and protrusions 24 are threaded into the internal surface of the drill shaped cavity 46.

While the present invention is described herein with reference to illustrative embodiments for particular applications, it should be understood that the invention is not limited thereto. Those having ordinary skill in the art and access to the teachings provided herein will recognize additional modifications, applications and embodiments within the scope thereof and additional fields in which the present invention would be of significant utility.

It is therefore intended by the appended claims to cover any and all such modifications, applications and embodiments within the scope of the present invention.

Accordingly,

What is claimed is:

1. A bi-polar implant system for use in a jawbone of a patient comprising:
a drill shaped cavity formed in a jawbone of a patient, said drill shaped cavity being undersized for receiving a bi-polar implant assembly, said bi-polar implant assembly comprising:
a proximal tapered portion positioned at a proximal end of said bi-polar implant assembly;
an expandable skirt portion adjacent to said proximal tapered portion for forming a distal end of said bi-polar implant assembly, said expandable skirt portion including a plurality of moveable bone anchor segments; and
a draw screw having a threaded shank portion positioned within said proximal tapered portion and cooperating with an expansion nut wherein rotation of said draw screw draws said expansion nut upwards into said expandable skirt portion for forcing said movable bone anchor segments into locking engagement with said jawbone;
said proximal tapered portion at said proximal end and said expandable skirt portion at said distal end exhibiting an hourglass shape for providing double compaction on said jawbone within said undersized drill shaped cavity for stabilizing said bi-polar implant assembly.

2. The bi-polar implant system of claim 1 wherein said proximal tapered portion is adjacent to a set of beveled coronal rings, said coronal rings being adjacent to an upper multi-sided collar having a circumference smaller than the circumference of said coronal rings.

3. The bi-polar implant system of claim 1 wherein said proximal tapered portion includes a tapered hood comprising an upper hood and a lower hood.

4. The bi-polar implant system of claim 1 wherein said proximal tapered portion includes a tapered tubular body comprising a plurality of internal threads for threadedly receiving an abutment.

5. The bi-polar implant system of claim 1 wherein said threaded shank portion is threadedly received into an inner threaded cavity of said expansion nut.

6. The bi-polar implant system of claim 1 wherein said draw screw includes a slotted head.

7. The bi-polar implant system of claim 1 wherein said proximal tapered portion further includes an internal shoulder upon which a slotted head of said draw screw rests.

8. The bi-polar implant system of claim 1 wherein said draw screw sealingly engages an internal shoulder of said proximal tapered portion for isolating a first hollow body chamber from a second hollow body chamber.

9. The bi-polar implant system of claim 1 wherein said expandable skirt portion includes a plurality of circumferentially-spaced tapered slits which define said movable bone anchor segments.

10. The bi-polar implant system of claim 1 wherein said expansion nut further includes a plurality of tabs that travel along a corresponding plurality of circumferentially-spaced tapered slits for preventing rotation of said expansion nut relative to said expandable skirt portion.

11. The bi-polar implant system of claim 1 wherein a portion of said proximal tapered portion is removed resulting in a non-circular circumference at any axial location in said proximal tapered portion.

12. The bi-polar implant system of claim 1 further including a prosthetic component mounted on an upper hood of said bi-polar implant assembly.

13. A bi-polar implant system for use in a jawbone of a patient comprising:
a drill shaped cavity formed in a jawbone of a patient, said drill shaped cavity being undersized for receiving a bi-polar implant assembly, said bi-polar implant assembly comprising:
a proximal tapered portion positioned at a proximal end of said bi-polar implant assembly;
an expandable skirt portion adjacent to said proximal tapered portion for forming a distal end of said bi-polar implant assembly;
bone engaging means formed on said proximal tapered portion and on a plurality of movable bone anchor segments of said expandable skirt portion for engaging an internal surface of said undersized drill shaped cavity for anchoring and preventing rotation of said bi-polar implant assembly; and
a draw screw having a threaded shank portion positioned within said proximal tapered portion and cooperating with an expansion nut wherein rotation of said draw screw draws said expansion nut upwards into said expandable skirt portion for forcing said bone engaging means into locking engagement with said jawbone;
said proximal tapered portion at said proximal end and said expandable skirt portion at said distal end exhibiting an hourglass shape for providing double compaction on said jawbone within said undersized, drill shaped cavity for stabilizing said bi-polar implant assembly.

14. The bi-polar implant system of claim 13 wherein said bone engaging means comprises a plurality of bone engaging protrusions formed on said proximal tapered portion.

15. The bi-polar implant system of claim 13 wherein said bone engaging means comprises a plurality of progressively tapered, bone penetrating protuberances formed on said movable bone anchor segments.

16. A bi-polar implant system for use in a jawbone of a patient comprising:
a drill shaped cavity formed in a jawbone of a patient, said drill shaped cavity being undersized for receiving a bi-polar implant assembly, said bi-polar implant assembly comprising:
a proximal tapered portion positioned at a proximal end of said bi-polar implant assembly;
an expandable skirt portion adjacent to said proximal tapered portion for forming a distal end of said bi-polar implant assembly;
self-tapping bone engaging means formed on said proximal tapered portion and on a plurality of movable bone anchor segments of said expandable skirt portion for engaging an internal surface of said undersized drill shaped cavity for anchoring and preventing rotation of said bi-polar implant assembly; and
a draw screw having a threaded shank portion positioned within said proximal tapered portion and cooperating with an expansion nut wherein rotation of said draw screw draws said expansion nut upwards into said expandable skirt portion for forcing said self-tapping bone engaging means into locking engagement with said jawbone;
said proximal tapered portion at said proximal end and said expandable skirt portion at said distal end exhibiting an hourglass shape for providing double compaction on said jawbone within said undersized, drill shaped cavity for stabilizing said bi-polar implant assembly.
